(19) United States
(12) Patent Application Publication
(10) Pub. No.: US 2005/0100020 A1
(43) Pub. Date: May 12, 2005

(54) Packet switching device

(76) Inventors: Akihiro Hata, Kawasaki (JP); Satoshi Sumino, Kawasaki (JP); Kazuto Nishimura, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/826,802

(22) Filed: Apr. 16, 2004

(30) Foreign Application Priority Data
Nov. 12, 2003 (JP) 2003-382851

(51) Int. Cl. H04L 12/56

(52) U.S. Cl. 370/395.21; 370/235

(57) ABSTRACT

A packet switching device for receiving and forwarding a packet, comprises a counter for indicating a storage capacity of specified packets in stored packets, and means for starting a forwarding restriction of the specified packets if the counter exceeds a preset forwarding restriction start threshold value. The forwarding restriction is a process of, e.g., lowering a priority of the specified packets in the received packets. The packet switching device further comprises means for canceling the forwarding restriction when the counter becomes smaller than a preset forwarding restriction terminating threshold value.

### BACKGROUND OF THE INVENTION

The invention relates to a technology for reducing, in a packet switching device (which may also be called a packet switch) for receiving and forwarding packets, influence of forwarding of specified packets upon forwarding of other packets, especially influence of the forwarding of broadcast packets upon the forwarding of the packets other than the broadcast packets.

There has hitherto occurred a state, wherein when transmitting a large quantity of broadcast packets, the packets rise in number as they are copied each time the packets pass through a packet switch, and the broadcast packets eventually occupy intra-packet-switch resources such as buffers, etc. required for forwarding the packets, resulting in inability to perform communications as by normal packets. This is called a broadcast storm. What has been proposed as a technology for preventing the broadcast storm is a technology in which a counter for counting the number of broadcast packets (packet count) having arrived for every fixed period of time is provided for every port, and the received broadcast packets are, if a counter value becomes equal to or larger than a certain threshold value, discarded till the counter value becomes equal to or smaller than the threshold value, and so forth (refer to, e.g., Patent document 1, etc.).

[Patent document 1] Japanese Patent Application Laid-Open Publication No.7-336373.

[Patent document 2] Japanese Patent Application Laid-Open Publication No.10-308735.

### SUMMARY OF THE INVENTION

The broadcast storm is caused by an occurrence of a loop (of hovering packets with their destinations lost) in a topology in a network such as Ethernet (registered trademark), etc., and by an attack from malicious users. The forwarding itself of the broadcast packets is one of normally-provided functions in the networks and should not be excluded unreasonably if within a range that does not exert adverse effects on the networks.

In the prior arts, the discard of the packets has been controlled by counting the number of broadcast packets having arrived for every period of time at each port.

Under the control by counting the packet count, however, it was impossible to detect a difference between a packet having a large data size (e.g., 16,000 bytes) and a packet having a small data size (e.g., 64 bytes) in the network (e.g., Ethernet) dealing with variable-length packets irrespective of an absolute difference between degrees of their influence exerted upon the network.

Further, in a switch having a plurality of ports, there was a case in which the broadcast packets, even if the number of the broadcast packets having arrived at each port is small, might occupy the intra-switch resources necessary for forwarding the packets when the broadcast packets reach the plurality of ports simultaneously.

Therefore, in the prior arts, as the number of the reached broadcast packets having the large size increases, or as the number of the broadcast packets having arrived simultaneously at the plurality of ports rises, the switch resources are occupied by the broadcast packets largely enough to depress other normal communications, and nevertheless a function of restricting the broadcast storm did not work, or conversely for avoiding such a state, an extremely low threshold value was set, and the broadcast storm restriction was made to work on even the broadcast packets having a rate as low as the resources of the packet switch are not occupied.

An object of the invention lies in preventing such an increase in specified packets (e.g., broadcast packets) as to affect general communications (such as an occurrence of a so-called broadcast storm, etc.) by effectuating a restriction of the specified packets (e.g., the broadcast packets) based on a storage capacity of the specified packets (e.g., the broadcast packets) in a packet switching device for receiving and forwarding packets.

The invention is devised to solve the problems and is a packet switching device receiving and forwarding a packet, comprising a counter indicating a storage capacity of specified packets in received packets, and means starting a forwarding restriction of the specified packets (e.g., broadcast packets) if the counter exceeds a preset forwarding restriction start threshold value.

According to the invention, the packet switching device for receiving and forwarding the packet, is capable of performing the forwarding restriction (a restriction of communications as by the specified packets) of the specified packets (e.g., the broadcast packets) on the basis of the storage capacity of the specified packets (e.g., the broadcast packets). It is therefore possible to prevent such an increase in specified packets (e.g., broadcast packets) as to affect general communications (such as an occurrence of a so-called broadcast storm, etc.). Besides, the restriction of the specified packets is based on not the packet count as in the prior art but on the storage capacity of the specified packets, and hence the specified packets can be restricted more properly in a network (e.g., Ethernet) dealing with variable-length packets.

Further, the invention can be specified as follows.

A packet switching device receiving and forwarding a packet comprises a counter, provided for every group to which specified packets belong, indicating a storage capacity of the specified packets belonging to the same group in received packets, and means starting, if the counter exceeds a preset forwarding restriction start threshold value, a forwarding restriction of the specified packets belonging to a group associated with the counter.

If thus constructed, in the same way as the above, the specified packets can be restricted more properly for every group in the network (e.g., Ethernet) dealing with the variable-length packets.

In the packet switching device, for instance, the specified packets are broadcast packets. The broadcast packet is exemplified such as a broadcast packet, a multicast packet, etc.

In the packet switching device, the forwarding restriction is, for example, a process of discarding the specified packets in the received packets without storing the specified packets. This is an exemplification of the forwarding restriction. Hence, the forwarding restriction according to the invention is not limited to what is exemplified herein. For instance, the forwarding restriction may be a process of lowering a priority of the specified packets in the received packets and may also be other forwarding restrictions. Note that the packet of which the priority is lowered is handled under packet priority control generally based on WRED (Weighted Random Early Discard) that is broadly carried out.

The packet switching device further comprises means canceling the forwarding restriction when the counter becomes smaller than, for example, a preset forwarding restriction terminating threshold value.

If thus contrived, it is possible to prevent unnecessary restriction control of the specified packets (e.g., the broadcast packets) from being conducted in a state that does not affect the general communications.

The packet switching device further comprises, for instance, means adding, in the case of receiving the specified packet, a size of the received specified packet to the counter, and for subtracting, in the case of forwarding the specified packet, a size of the forwarded specified packet from the counter.

This is an exemplification of a counting method by use of the counter indicating the storage capacity of the specified packets in the stored packets. Hence, the counting method of the counter according to the invention is not confined to what is exemplified herein and may also be other counting methods.

The packet switching device further comprises, for instance, means adding, in the case of receiving the specified packet, a size of the received specified packet to the counter associated with a group to which this specified packet belongs, and for subtracting, in the case of forwarding the specified packet, a size of the forwarded specified packet from the counter associated with the group to which the specified packet belongs.

This is also an exemplification of the counting method by use of the counter indicating the storage capacity of the specified packets in the stored packets. Therefore, the counting method of the counter according to the invention is not limited to what is exemplified herein and may also be other counting methods.

The invention can be also specified as below.

A packet switching device receiving and forwarding a packet comprises means forwarding, if a specified packet and a packet other than the specified packet are stored, the packet other than the specified packet ahead of the specified packet.

If thus constructed, the unicast packet is preferentially read from the buffer, and, even in a state where the broadcast packets are stored on the buffer, it is possible to prevent influence from being exerted on the unicast communications.

Moreover, the invention can be specified as an invention of a method.

A packet forwarding restriction method by which a packet switching device receiving and forwarding a packet executes a forwarding restriction of specified packets, comprises starting the forwarding restriction of the specified packets by the packet switching device if a counter indicating a storage capacity of the specified packets in received packets exceeds a preset forwarding restriction start threshold value.

A packet forwarding control method by which a packet switching device for receiving and forwarding a packet executes a forwarding restriction of specified packets, comprises starting, if a counter, provided for every group to which specified packets belong, for indicating a storage capacity of the specified packets belonging to the same group exceeds a preset forwarding restriction start threshold value, the forwarding restriction of the specified packets belonging to a group associated with the counter by the packet switching device.

Moreover, the invention can be specified as below.

A packet switching device for receiving and forwarding a packet, comprises means for counting a storage size of a specified packet by adding, in the case of receiving the specified packet, a size of the received specified packet, and by subtracting, in the case of forwarding the specified packet, a size of the forwarded specified packet.

If thus constructed, the packet switching device for receiving and forwarding the packet, is capable of restricting the specified packets (e.g., the broadcast packets) on the basis of the storage capacity of the specified packets (e.g., the broadcast packets). It is therefore possible to prevent such an increase in specified packets (e.g., broadcast packets) as to affect general communications (such as an occurrence of a so-called broadcast storm, etc.). Besides, the restriction of the specified packets is based on not the packet count as in the prior art but on the storage capacity of the specified packets, and hence the specified packets can be restricted more properly in a network (e.g., Ethernet) dealing with variable-length packets.

Further, the invention can be specified as follows.

A packet switching device for receiving and forwarding a packet, comprises means for counting a group-by-group storage size of packets by effecting grouping based on information added to packets, adding a packet size on a group-by-group basis in the case of receiving the specified packets, and subtracting a packet size on the group-by-group basis in the case of forwarding the specified packets.

If this constructed, in the same way as the above, in the network (e.g., Ethernet) dealing with the variable-length packets, the specified packets can be restricted more properly on the group-by-group basis. Note that the information added to the packet is exemplified such as VLAN (Virtual LAN) Tag, Ether Type, MPLS (Multi Protocol Label Switching) Label, etc.

In the packet switching device, for example, the specified packet is the broadcast packet. The broadcast packet is exemplified such as the broadcast packet, the multicast packet and so on.

In the packet switching device, for instance, if a value counted by the counting means exceeds a predetermined threshold value, a part or the whole of specified packets are discarded by way of a forwarding restriction. This is an exemplification of the forwarding restriction. Therefore, the forwarding restriction according to the invention is not limited to what is exemplified herein. For instance, if a value counted by the counting means exceeds a predetermined threshold value, a priority of a part or the whole of specified packets may be lowered by way of a forwarding restriction, and other forwarding restrictions may also be performed. Note that the packet of which the priority is lowered is handled under the packet priority control generally based on WRED (Weighted Random Early Discard) that is broadly carried out.

The packet switching device includes, for example, means for canceling the forwarding restriction if a value counted by the counting means becomes smaller than a predetermined threshold value.

If thus constructed, it is feasible to prevent the unnecessary restriction control of the specified packets (e.g., the broadcast packets) in a state that does not affect the general communications.

The packet switching device includes means for canceling the forwarding restriction if a fixed period of time elapses since the forwarding restriction has been started. This is an exemplification of forwarding cancellation. Hence, the invention is not confined to what is exemplified herein. Other forwarding cancellation may also be performed.

The packet switching device further comprises, for example, a buffer stored with the received packets, and includes means for setting such a threshold value as to become equal to or smaller than a fixed ratio (<1) with respect to the buffer.

With this contrivance, it is feasible to prevent the buffer from being occupied by the specified packets. Namely, an occurrence of an overflow from the buffer due to the broadcast storm can be avoided.

The packet switching device includes means for setting a readout priority of the specified packets lower than that of unicast packets.

Owing to this contrivance, the storage of the specified packets into the buffer does not affect unicast communications. Namely, the unicast packets are preferentially read from the buffer, and it is possible to prevent the unicast communications from being affected even in a state of the buffer being stored with the broadcast packets. Further, if a total band of the broadcast packets arriving at the output-side port and of the unicast packets is larger than a physical band of the output-side port, the forwarding of the broadcast packets is restricted, and the broadcast packets are discarded before an adverse effect is exerted on the packet buffer because of the packets being consecutively stored in the packet buffer and because of the broadcast packet storage byte counting means eventually exceeding the threshold value.

The packet switching device includes, for example, means for setting such a threshold value that a total sum of the threshold values of all the groups becomes equal to or smaller than a fixed ratio (<1) with respect to the buffer possessed by the device.

With this contrivance, the buffer occupation by the broadcast packets is managed on the group-by-group basis, and the buffer occupation by the broadcast packets of a specified group does not affect other groups. That is, the occurrence of the broadcast storm can be restrained group by group, and the broadcast storm having occurred in a certain group can be prevented from affecting different groups. This is effective in such a mode that the packet switch of the invention is applied to a carrier network and one single packet switch accommodates a plurality of users distinguished by VLAN Tag, etc.

According to the invention, in the packet switching device (which may also be called the packet switch) for receiving and forwarding the packets, it is possible to reduce influence of the forwarding of the specified packets upon the forwarding of other packets, especially influence of the forwarding of the broadcast packets upon the forwarding of the packets excluding the broadcast packets. For instance, the switch resources are occupied by the broadcast packets due to an occurrence of the broadcast storm, wherein other normal communications can be prevented from being affected. Further, a futile discard of the broadcast packets can be prevented under a still-ample state of the switch resources.

### DESCRIPTION OF THE DRAWINGS

FIG. 1 is a functional block diagram showing an Ethernet switch by way of a first embodiment of the invention.

FIG. 2 is an explanatory diagram of a packet discard control occurrence canceling procedure in the first embodiment of the invention.

FIG. 3 is a functional block diagram showing the Ethernet switch by way of a second embodiment of the invention.

FIG. 4 is an explanatory diagram of a packet low prioritization control occurrence canceling procedure in the second embodiment of the invention.

FIG. 5 is an IEEE 802.1Q based VLAN packet format.

### DETAILED DESCRIPTION OF THE INVENTION

An Ethernet (registered trademark) switch will hereinafter be described with reference to the drawings by way of a first embodiment of the invention.

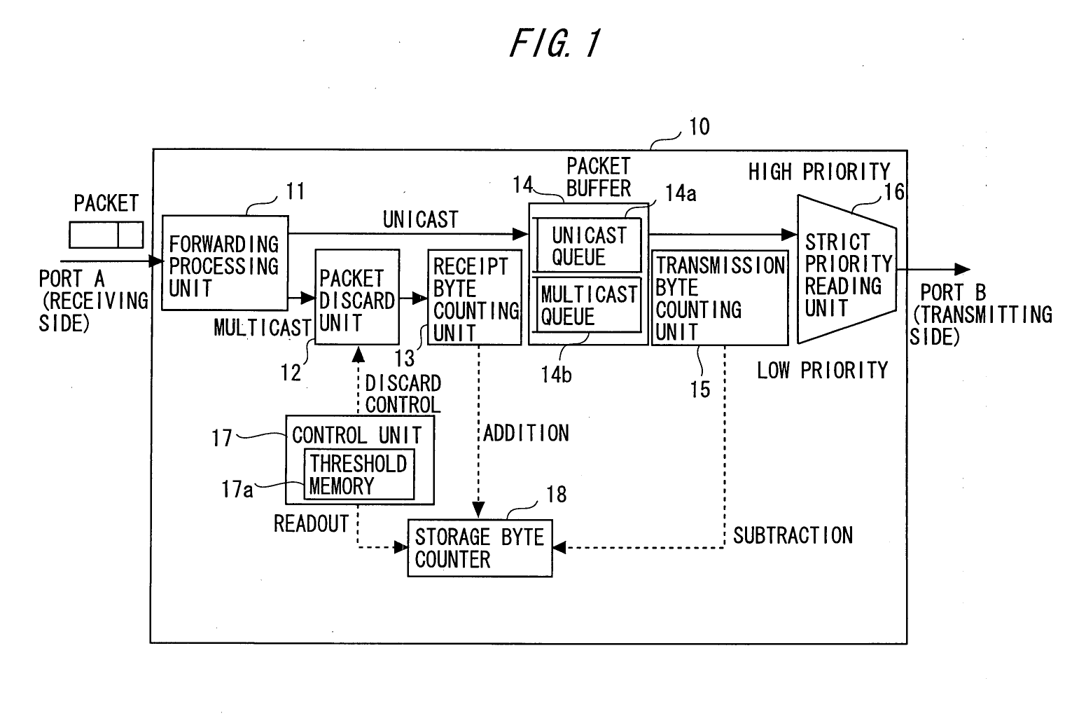

To begin with, a configuration and functions of the Ethernet switch as the first embodiment will be outlined. FIG. 1 is a functional block diagram of the Ethernet switch as the first embodiment of the invention.

An Ethernet switch 10 in the first embodiment is a packet switching device for receiving and storing a packet (Ethernet frame) and thereafter forwarding the packet, and has ports (A) and (B) connectable to a network via a connector. Further, the Ethernet switch 10 includes a forwarding processing unit 11, a packet discard unit 12, a number-of-receipt-bytes (receipt byte count) counting unit 13, a packet buffer 14, a number-of-transmission-bytes (transmission byte count) counting unit 15, a Strict Priority reading unit 16, a control unit 17 and a number-of-storage-bytes (storage byte count) counter 18.

The forwarding processing unit 11 reads necessary pieces of information such as a destination address, etc. from the packet received at the port (A). The forwarding processing unit 11, if the destination address of the packet is a broadcast address or a multicast address, transfers the packet as a broadcast packet to the packet discard unit 12. By contrast, if the destination address is a unicast address, the forwarding process 11 executes a process of searching for a destination. As a result, if the destination is found out, the packet is processed as a unicast packet and transferred to a unicast queue 14a of the packet buffer 14. Whereas if the destination is not found out, the packet is transferred as a flooding packet to the packet discard unit 12 as in the case of the broadcast packet and the multicast packet.

The packet discard unit 12, when discard control is implemented by the control unit 17, discards the broadcast packet, and, when the discard control is not implemented, transfers the broadcast packet to the receipt byte counting unit 13.

The receipt byte counting unit 13 measures a data size of the reached broadcast packet, then adds this size to the storage byte counter 18, and transfers the broadcast packet to a multicast queue 14b of the packet buffer 14.

The transmission byte counting unit 15, in the case of reading the broadcast packet from the multicast queue 14b and forwarding this packet, measures a size of the broadcast packet forwarded, and subtracts this size from the storage byte counter 18.

The control unit 17 monitors the storage byte counter 18, makes a comparison between a value (corresponding to a forwarding restriction start threshold value according to the invention) set in a threshold memory 17b and the storage byte counter 18, and, if the value indicated by the storage byte counter 18 exceeds the threshold value, executes the broadcast packet discard control over the packet discard unit 12 (which corresponds to a start of a forwarding restriction according to the invention).

The storage byte counter 18 is a counter indicating a storage capacity of the broadcast packets (corresponding to specified packets according to the invention) among the packets stored on the packet buffer 14 (which correspond to stored packets according to the invention).

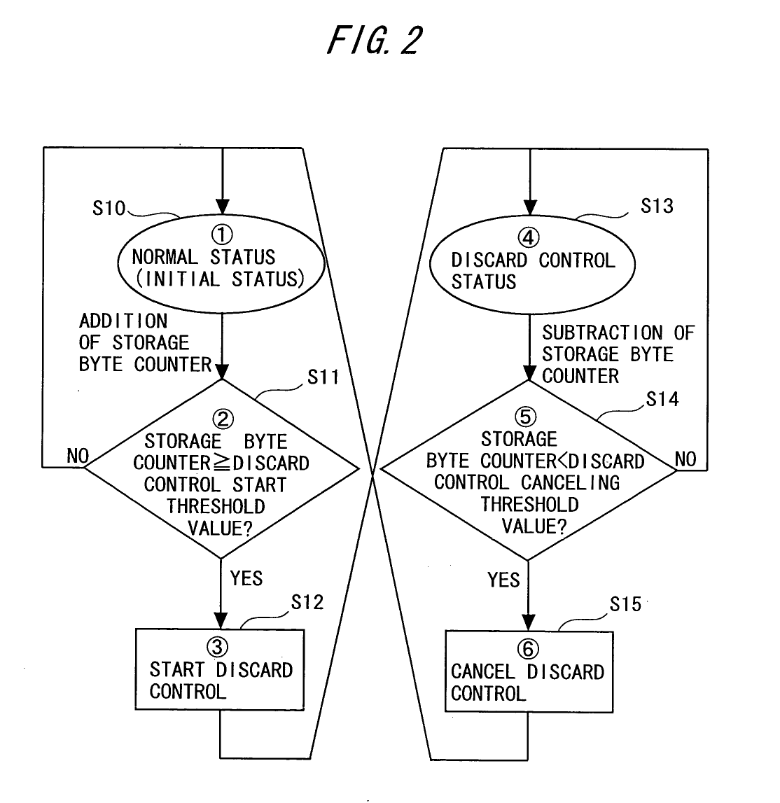

Next, a procedure of canceling an occurrence of the packet discard control by the control unit 17 will be explained. FIG. 2 is an explanatory diagram of the packet discard control occurrence canceling procedure in the first embodiment of the invention.

To begin with, when starting an operation of the Ethernet switch, the procedure is in an initial status (1) (S10). Effectuation of a comparison (2) between the storage byte counter 18 and a start threshold value of the discard control is triggered (S11) by an addition of the storage byte counter 18 from the initial status (1). Note that circled numerals in FIG. 2 correspond to (1), etc. If the storage byte counter 18 does not exceed the discard control start threshold value (S11: No), the procedure returns to the normal status (1). If the storage byte counter 18 exceeds the discard control start threshold value (S11: Yes), the broadcast packet discard control is started (3) (S12). When starting the broadcast packet discard control, the procedure moves to a discard control status (4) (S13). Effectuation of a comparison (5) between the storage byte counter 18 and a cancel threshold value of the discard control is triggered this time by a subtraction of the storage byte counter 18 (S14). If the storage byte counter 18 is not lower than the discard control cancel threshold value (S14: No), the discard control status (4) remains unchanged. If the storage byte counter 18 becomes smaller (lower) than the discard control cancel threshold value (S14: Yes), the broadcast packet discard control is canceled (6) (S15), the procedure returns to the normal status (1). At this time, such a value having a fixed ratio to the capacity of the packet buffer 14 that the storage of the broadcast packets equal to or less than the discard control start threshold value into the packet buffer 14 does not affect unicast communications, is set as the discard control start threshold value. Further, a value having hysteresis about the discard control start threshold value may also be set. In this case, it is possible to prevent an intermittent occurrence of the instantaneous discard control.

The packets queued in the unicast queue 14a and in the multicast queue 14b of the packet buffer 14 are read by the Strict Priority reading unit 16. The Strict Priority reading unit 16, in the case of the packets being queued in both of the queues 14a and 14b, reads preferentially the packets queued in the unicast queue 14a. It is to be noted that when none of the packets are queued in the unicast queue 14a, the Strict Priority reading unit 16 reads the broadcast packets from the multicast queue 14b. If a broadcast packet coming to the head of the multicast queue 14b is not read for a fixed period of time, this broadcast packet is discarded. The Strict-Priority-based readout being thus performed, even if a tremendous quantity of broadcast packets arrive, the broadcast packets do not depress the unicast packets in terms of a rate in a physical band of the port (B). Note that a variation of the buffer readout control is not limited to the readout based on the Strict Priority. Other various types of readout control can be conducted. There is considered, for example, an implementation of allocating a minimum assured band to the forwarding of the broadcast packet by use of WFQ (Weight Fair Queue).

When reading the broadcast packets from the multicast queue 14b (or in the case of forwarding the broadcast packets), and when discarding the broadcast packets from the multicast queue 14b, the transmission byte counting unit 15 adds a byte count of the broadcast packets read out (or forwarded) or discarded to the storage byte counter 18, or subtracts the byte count from the storage byte counter 18.

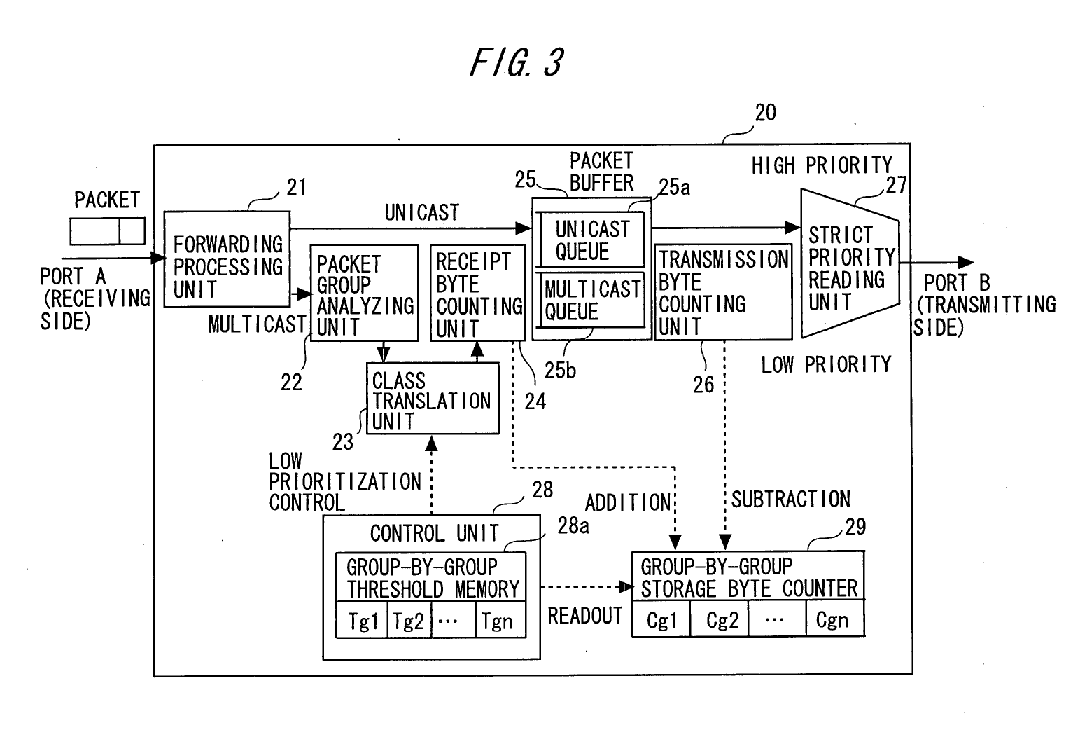

Next, a configuration and functions of the Ethernet switch as a second embodiment will be outlined. FIG. 3 is a functional block diagram of the Ethernet switch as the second embodiment of the invention.

An Ethernet switch 20 in the second embodiment is likewise, as in the first embodiment, a packet switching device for receiving and storing a packet (Ethernet frame) and thereafter forwarding the packet, and has ports (A) and (B) connectable to the network via the connector. Further, the Ethernet switch 20 includes a forwarding processing unit 21, a packet group analyzing unit 22, a Class translation unit 23, a number-of-receipt-bytes (receipt byte count) counting unit 24, a packet buffer 25, a number-of-transmission-bytes (transmission byte count) counting unit 26, a Strict Priority reading unit 27, a group-by-group byte counter 28 and a control unit 29.

The forwarding processing unit 21 reads necessary pieces of information such as a destination address, etc. from the packet received at the port (A). The forwarding processing unit 21, if the destination address of the packet is a broadcast address or a multicast address, transfers the packet as a broadcast packet to the packet group analyzing unit 22. In contrast, if the destination address is a unicast address, the forwarding process 21 executes a process of searching for a destination. As a result, if the destination is found out, the packet is processed as a unicast packet and transferred to a unicast queue 25a of the packet buffer 25. Whereas if the destination is not found out, the packet is transferred as a flooding packet to the packet group analyzing unit 22 as in the case of the broadcast packet and the multicast packet.

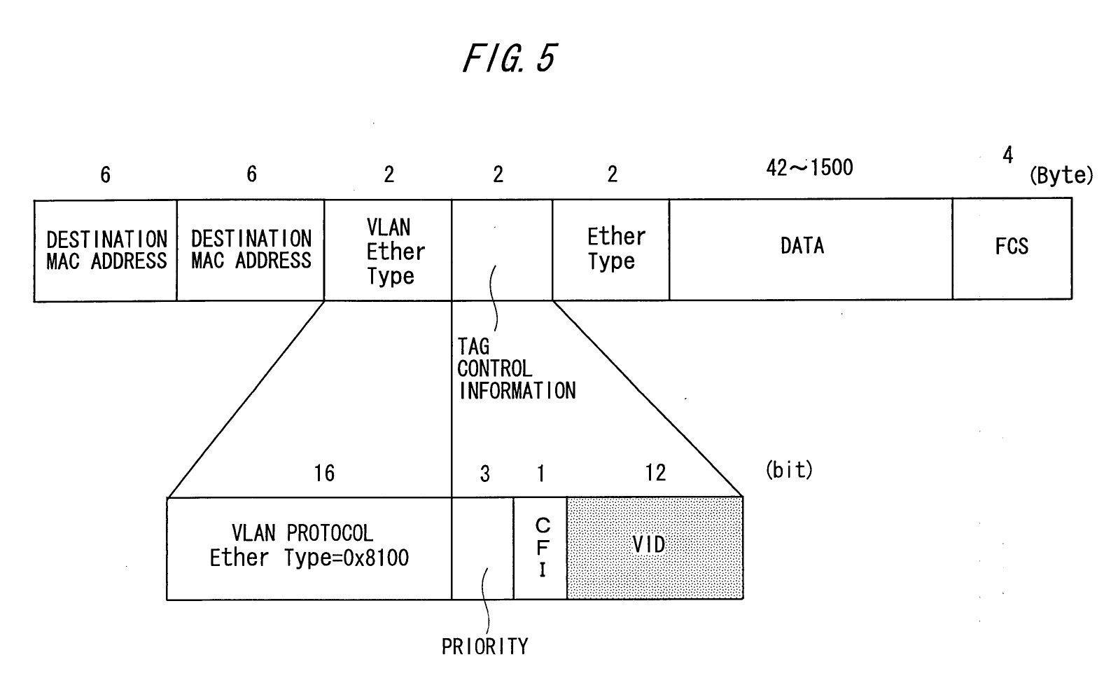

The packet group analyzing unit 22 effects grouping of the broadcast packets on the basis of information added to the broadcast packets. The information added to the broadcast packet is exemplified such as VLAN (Virtual LAN) Tag as defined in IEEE 802.1Q, and so on. For reference, FIG. 5 shows a format of a packet attached with VLAN (Virtual LAN) tag. Herein, the grouping is effected based on the VLAN Tag information, and a piece of information about a group to which the broadcast packet belongs is transferred together with the broadcast packet to the Class translation unit 23.

The Class translation unit 23, if the received broadcast belongs to a group subjected to low prioritization control, the control of lowering the priority of the broadcast packet is executed, and the broadcast packet and the group information are transferred to the receipt byte counting unit 24. In the case of belonging to a group that is not subjected to the low prioritization control, the broadcast packet and the group information are transferred directly to the receipt byte counting unit 24 without changing the priority.

The receipt byte counting unit 24 measures a data size of the reached broadcast packet, then adds this size to the storage byte counter 29 associated with a group to which this broadcast packet belongs, and transfers the broadcast packet and the group information to a multicast queue 25b of the packet buffer 25 dispose posterior thereto.

The transmission byte counting unit 26, in the case of reading the broadcast packet from the multicast queue 25b and forwarding this packet, measures a size of the broadcast packet forwarded, and subtracts this size from the storage byte counter 29 associated with the group to which this broadcast packet belongs.

The group-by-group storage byte counter 29 has storage byte counters Cg1-Cgn for respective groups, thereby managing the number of bytes (byte count) of the broadcast packets to every group. Namely, the group-by-group storage byte counter 29 is a group of counters (Cg1-Cgn) provided for respective groups to which the broadcast packets (corresponding to specified packets according to the invention) and each indicating a storage capacity of the broadcast packets belonging to the same group in the packets stored on the packet buffer 25 (which correspond to stored packets according to the invention).

The control unit 28, which retains threshold values Tg1-Tgn for respective groups on its threshold memory 28a for every group, monitors the group-by-group storage byte counters Cg1-Cgn, and compares the threshold values Tg1-Tgn with the storage byte counters Cg1-Cgn. If the values in the storage byte counters Cg1-Cgn exceed the threshold values Tg1-Tgn, the control unit 28 effects the low prioritization control of the broadcast packet to the group where the excess over the threshold value occurs, over the Class translation unit (3) (which corresponds to a start of the forwarding restriction according to the invention).

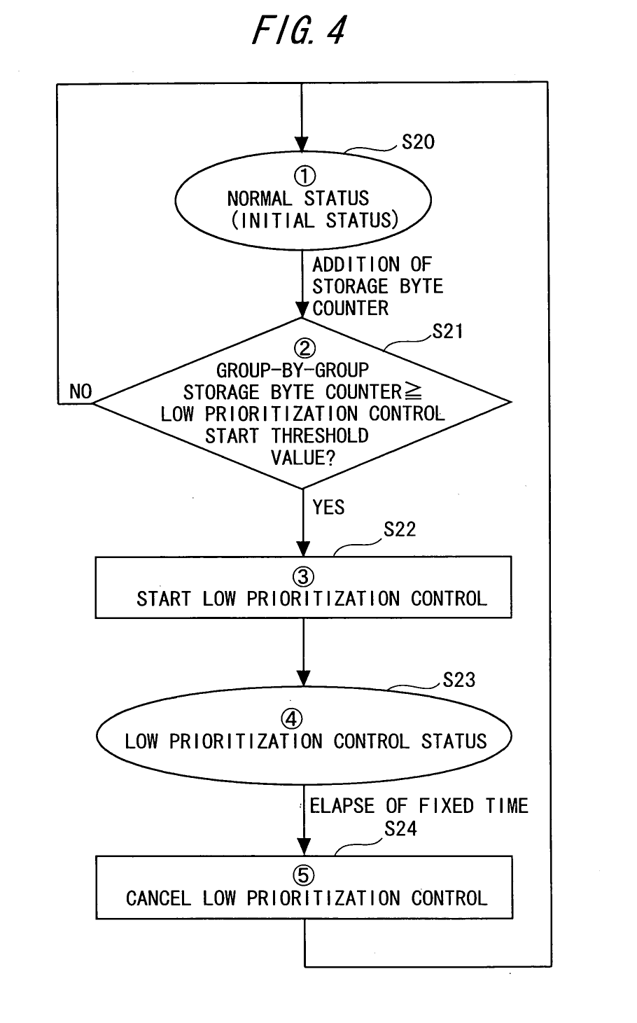

Next, a procedure of canceling an occurrence of the packet low prioritization control by the control unit 28 will be explained. FIG. 4 is an explanatory diagram of the packet low prioritization control occurrence canceling procedure in the second embodiment of the invention.

At first, when starting an operation of the Ethernet switch, the procedure is in an initial status (1) (S20). Effectuation of a comparison (2) between the group-by-group storage byte counter 29 and a low prioritization control start threshold value 28a is triggered by an addition of the storage byte counter 29 from the initial status (1) (S21). If the storage byte counter 29 does not exceed the threshold value (S21: No), the procedure returns to the normal status (1). If the storage byte counter 29 exceeds the threshold value (S21: Yes), the broadcast packet low prioritization control is started (3) (S22). The procedure returns to the low prioritization control status (4) (S23), and, upon an elapse of a fixed period of time, the broadcast packet low prioritization control is canceled (5) (S24), and the procedure moves back to the normal status (1). At this time, a total sum of the low prioritization control start threshold values for the respective groups, is set to a value equal to or smaller than a fixed rate to a total capacity of the packet buffer 25.

The packets queued in the unicast queue 25a and in the multicast queue 25b of the packet buffer 25 are read by the Strict Priority reading unit 27. The control of the Strict Priority reading unit 27 is the same as the control in the first embodiment.

When reading the broadcast packets from the multicast queue 25b and when discarding the broadcast packets from the multicast queue 25b, the transmission byte counting unit 26 adds a byte count of the broadcast packets read out or discarded to the group-by-group storage byte counter 29 for the group to which the broadcast packets belong, or subtracts the byte count from the group-by-group storage byte counter 29 for the group to which the broadcast packets belong.

The invention can be embodied in a variety of forms without deviating from the sprit or the principal features thereof. Therefore, the embodiments are nothing but mere exemplifications in every aspect and must not be construed in a limited manner.

### Industrial Applicability

According to the invention, in the packet switching device (which may also be called the packet switch) for receiving and forwarding the packets, it is possible to reduce influence of the forwarding of the specified packets upon the forwarding of other packets, especially influence of the forwarding of the broadcast packets upon the forwarding of the packets excluding the broadcast packets. For instance, the switch resources are occupied by the broadcast packets due to an occurrence of the broadcast storm, wherein other normal communications can be prevented from being affected. Further, a futile discard of the broadcast packets can be prevented under a still-ample state of the switch resources.

1. A packet switching device receiving and forwarding a packet, comprising:
a counter indicating a storage capacity of specified packets; and
means starting a forwarding restriction of the specified packets if said counter exceeds a preset forwarding restriction start threshold value.

2. A packet switching device receiving a packet and, after storing the packet, forwarding the packet, comprising:
a counter, provided for every group to which specified packets belong, indicating a storage capacity of the specified packets belonging to the same group in received packets; and
means starting, if said counter exceeds a preset forwarding restriction start threshold value, a forwarding restriction of the specified packets belonging to a group associated with said counter.

3. A packet switching device according to claim 1, wherein the forwarding restriction is a process of discarding the specified packets in the received packets without storing the specified packets.

4. A packet switching device according to claim 1, wherein the forwarding restriction is a process of lowering a priority of the specified packets in the received packets.

5. A packet switching device according to claim 1, further comprising means canceling the forwarding restriction when said counter becomes smaller than a preset forwarding restriction terminating threshold value.

6. A packet switching device according to claim 1, further comprising means adding, in the case of receiving the specified packet, a size of the received specified packet to said counter, and subtracting, in the case of forwarding the specified packet, a size of the forwarded specified packet from said counter.

7. A packet switching device according to claim 2, further comprising means adding, in the case of receiving the specified packet, a size of the received specified packet to said counter associated with a group to which this specified packet belongs, and subtracting, in the case of forwarding the specified packet, a size of the forwarded specified packet from said counter associated with the group to which the specified packet belongs.

8. A packet switching device receiving and forwarding a packet, comprising:
means receiving a packet and storing the packet in a memory; and
means forwarding, if a specified packet and a packet other than the specified packet are stored, the packet other than the specified packet ahead of to the specified packet.

9. A packet switching device according to any one of claim 1, wherein the specified packet is a broadcast packet.

10. A packet forwarding restriction method by which a packet switching device receiving and forwarding a packet executes a forwarding restriction of specified packets, comprising:
comparing a preset forwarding restriction start threshold value with a counter for indicating a storage capacity of the specified packets in received packets; and
starting the forwarding restriction of the specified packets by said packet switching device if the counter exceeds the preset forwarding restriction start threshold value.

11. A packet forwarding control method by which a packet switching device receiving and forwarding a packet executes a forwarding restriction of specified packets, comprising:
comparing a preset forwarding restriction start threshold value with a counter, provided for every group to which specified packets belong, indicating a storage capacity of the specified packets belonging to the same group; and
starting, if the counter exceeds the preset forwarding restriction start threshold value, the forwarding restriction of the specified packets belonging to a group associated with said counter by said packet switching device.

12. A packet switching device receiving and forwarding a packet, comprising:
means counting a storage size of a specified packet by adding, in the case of receiving the specified packet, a size of the received specified packet; and
means counting a storage size of a specified packet by subtracting, in the case of forwarding the specified packet, a size of the forwarded specified packet.

13. A packet switching device receiving and forwarding a packet, comprising:
means counting a group-by-group storage size of packets by effecting grouping based on information added to packets, adding a packet size on a group-by-group basis in the case of receiving the specified packets; and
means counting a group-by-group storage size of packets by effecting grouping based on information added to packets, subtracting a packet size on the group-by-group basis in the case of forwarding the specified packets.

14. A packet switching device according to claim 12, wherein if a value counted by said counting means exceeds a predetermined threshold value, a part or the whole of specified packets are discarded by way of a forwarding restriction.

15. A packet switching device according to claim 12, wherein if a value counted by said counting means exceeds a predetermined threshold value, a priority of a part or the whole of specified packets is lowered by way of a forwarding restriction.

16. A packet switching device according to claim 14, wherein if a value counted by said counting means becomes smaller than a predetermined threshold value, the forwarding restriction is canceled.

17. A packet switching device according to claim 14, wherein if a fixed period of time elapses since the forwarding restriction has been started, the forwarding restriction is canceled.

18. A packet switching device according to claim 14, further comprising a buffer stored with the received packets,
wherein said buffer is prevented from being occupied with the specified packets by setting such a threshold value as to be equal to or less than a fixed ratio with respect to said buffer.

19. A packet switching device according to claim 14, wherein the storage of the specific packets into said buffer does not affect unicast communications by setting a readout priority of the specified packets lower than that of unicast packets.

20. A packet switching device according to claim 14, wherein buffer occupation by the broadcast packets is managed on a group-by-group basis by setting such a threshold value that a total sum of threshold values of all the groups becomes equal to or smaller than a fixed ratio with respect to said buffer possessed by said device, whereby the buffer occupation by the broadcast packet of a specified group does not affect other groups.
